(19) United States
(12) Patent Application Publication
(10) Pub. No.: US 2020/0023847 A1
(43) Pub. Date: Jan. 23, 2020

(54) TRAVEL CONTROL DEVICE, VEHICLE, AND TRAVEL CONTROL METHOD

(71) Applicant: Isuzu Motors Limited, Tokyo (JP)

(72) Inventors: Naoki TAKAHASHI, Fujisawa-shi (JP); Masaichi TAKAHASHI, Fujisawa-shi (JP)

(73) Assignee: Isuzu Motors Limited, Tokyo (JP)

(21) Appl. No.: 16/496,432

(22) PCT Filed: Mar. 16, 2018
(86) PCT No.: PCT/JP2018/010558

§ 371 Date: Sep. 22, 2019

(30) Foreign Application Priority Data
Mar. 22, 2017 (JP) 2017-056564

(51) Int. Cl. B60W 30/18; B60W 10/04; B60W 10/18

(52) U.S. Cl. CPC B60W 30/18072; B60W 10/04; B60W 2520/10; B60W 2710/18; B60W 2720/106; B60W 10/18

(57) ABSTRACT

Provided are a travel control device, a vehicle, and a travel control method that reduce driver discomfort while making it possible to further improve the fuel economy of the vehicle. This travel control device controls switching of vehicle travel between propulsion travel whereby the vehicle is made to travel while maintaining the vehicle speed at a target speed and coasting travel whereby the vehicle is made to travel by inertia, and is equipped with a travel control unit that, in cases in which the vehicle speed during coasting travel has exceeded the allowable maximum speed of a prescribed range, switches travel of the vehicle from coasting travel to propulsion travel and causes the vehicle to brake, and once the vehicle speed has decreased to a prescribed speed that is above the target speed, releases braking of the vehicle.

### TECHNICAL FIELD

This disclosure relates to a travel control device for controlling the travel of a vehicle, a vehicle, and a travelling control method.

### BACKGROUND ART

Conventionally, there is known a travel control device which controls the automatic traveling of a vehicle (traveling without requiring the driver's operation).

For example, Patent Literature 1 discloses a travel control device that performs a control in which the vehicle velocity is maintained at a set velocity (hereinafter referred to as the target vehicle velocity) to run the vehicle (driving travel).

For example, in Patent Literature 2, there is disclosed a travel control device which performs a control for allowing the vehicle to travel by inertia (inertia traveling) by temporarily stopping an engine and disconnecting a power transmission mechanism provided in a power transmission system between a transmission and the engine or between the transmission and wheels when predetermined conditions are satisfied while the vehicle is traveling.

### CITATION LIST

### Patent Literature

PTL 1: Japanese Patent Application Laid-Open No. 2017-024479
PTL 2: Japanese Patent Application Laid-Open No. 2006-200370

### SUMMARY OF INVENTION

### Technical Problem

When the velocity of the vehicle exceeds the allowable maximum velocity in the predetermined range during the inertia traveling, the traveling of the vehicle is switched from the coasting travel to the driving travel. When the driving operation is switched to the driving travel, for example, the auxiliary brake is operated. The operation of the auxiliary brake is released when the velocity of the vehicle reaches the target vehicle velocity.

However, since the velocity of the vehicle is greatly reduced until the auxiliary brake is released from the start of the operation of the auxiliary brake, the driver may feel uncomfortable. Further, the auxiliary brake is continuously operated during this period, which causes a problem in that improvement of the fuel efficiency of the vehicle is hindered.

It is an object of this disclosure to provide a travel control device, a vehicle and a travel control method which can reduce the discomfort of a driver and further improve the fuel efficiency of a vehicle.

### Solution to Problem

A travel control device of the present disclosure is a travel control device that performs a switching control for traveling of a vehicle between driving travel for causing the vehicle to travel while maintaining the velocity at a target vehicle velocity and inertia traveling for allowing the vehicle to travel by inertia, the travel control device including:

a travel control section that switches the travel of the vehicle from inertia traveling to driving travel and brakes the vehicle when the velocity of the vehicle exceeds an allowable maximum velocity of a predetermined range during inertia traveling, and that releases the brake of the vehicle when the velocity of the vehicle decreases to a predetermined velocity above the target vehicle velocity.

A vehicle of the present disclosure includes the travel control device described above.

A travel control method of the present disclosure is a travel control method for performing a switching control for traveling of a vehicle between driving travel for causing the vehicle to travel while maintaining the velocity at a target vehicle velocity and inertia traveling for allowing the vehicle to travel by inertia, the travel control method including:

switching the travel of the vehicle from inertia traveling to driving travel and braking the vehicle when the velocity of the vehicle exceeds an allowable maximum velocity of a predetermined range during inertia traveling, and releasing the braking of the vehicle when the velocity of the vehicle decreases to a predetermined velocity above the target vehicle velocity.

### Advantageous Effects of Invention

According to this disclosure, it is possible to reduce the discomfort to the driver and to further improve the fuel efficiency of the vehicle.

### BRIEF DESCRIPTION OF DRAWINGS

FIG. 1 is a block diagram illustrating an example of a configuration of a vehicle including a travel control device according to the present embodiment;

FIG. 2 is a block diagram illustrating an example of a configuration of a travel control device according to the present embodiment;

FIG. 3 is a diagram illustrating an example of road gradient information and a traveling schedule on a road; and

FIG. 4 is a flowchart illustrating an example of an operation example of the travel control in the travel control section.

### DESCRIPTION OF EMBODIMENTS

Hereinafter, embodiments of this disclosure will be described in detail with reference to the drawings.

<Example of Configuration of Vehicle 1>

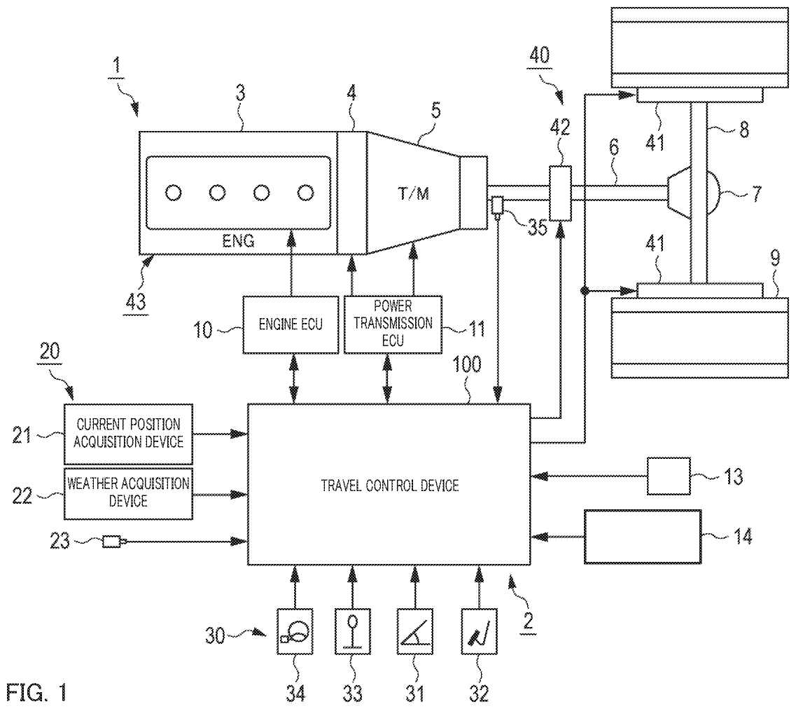

First, the configuration of a vehicle including travel control device 100 according to the present embodiment will be described. FIG. 1 is a block diagram illustrating an example of a configuration of the vehicle including travel control device 100 according to the present embodiment. Hereinafter, a description will be given focusing on a portion related to travel control device 100.

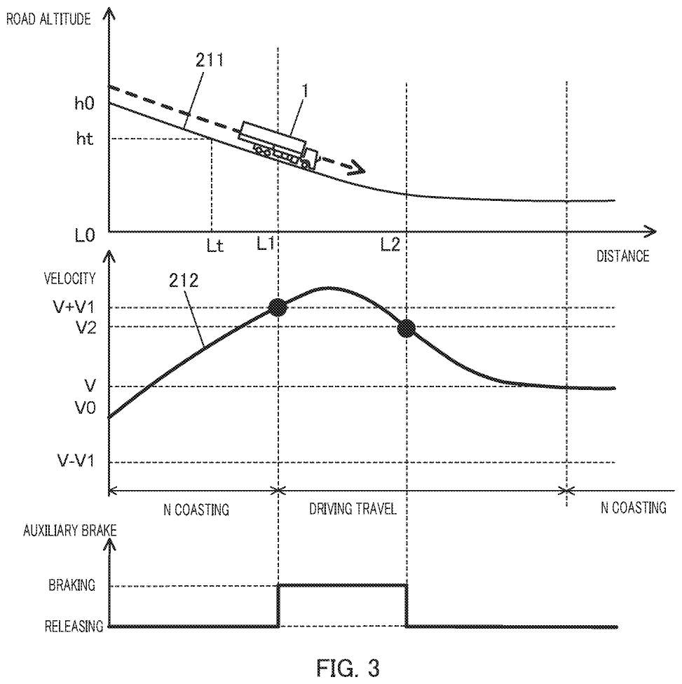

Vehicle 1 is a vehicle capable of switching between driving travel and coasting. The driving travel (also referred to as constant velocity traveling) is a travel in which vehicle 1 is travelled to drive wheels 9 by a drive system to be described later to maintain the target vehicle velocity (target vehicle velocity V illustrated in FIG. 3). The coasting is traveling in which vehicle 1 is driven by using the inertial force without driving wheels 9 by a drive system described later.

In the present embodiment, as an example, a case where coasting is a neutral inertia traveling (hereinafter referred to as “N coasting”) in which the gear stage of the transmission is neutral will be described as an example, but the present invention is not limited thereto, and the free-run inertia traveling may also be used. While the N coasting is performed by supplying the fuel to the engine in a state where the clutch in the power transmission path is disengaged and the engine is disconnected from the wheels, the free-run inertia traveling is performed by stopping the supply of fuel to the engine in a state where the clutch in the power transmission path is disengaged and the engine is disconnected from the wheels.

Vehicle 1 illustrated in FIG. 1 is a large vehicle such as a truck on which a series 6 cylinder diesel engine is mounted, for example.

As illustrated in FIG. 1, vehicle 1 includes engine 3, clutch 4, transmission 5, propulsion shaft (propeller shaft) 6, differential device (differential gear) 7, drive shaft 8, and wheels 9 as a configuration of a drive system for traveling the vehicle.

Power of engine 3 is transmitted to transmission 5 via clutch 4, and the power transmitted to transmission 5 is further transmitted to wheels 9 via propulsion shaft 6, differential device 7, and drive shaft 8. Thus, power of engine 3 is transmitted to wheels 9, and vehicle 1 travels.

Further, vehicle 1 has braking device 40 as a structure of a braking system for stopping the vehicle. Braking device 40 includes foot brake 41 which imparts a resistance force to wheels 9, retarder 42 which applies a resistance force to propulsion shaft 6, and an auxiliary brake 43 such as an exhaust brake which applies a load to the engine.

Further, vehicle 1 has automatic traveling device 2 as a configuration of a control system for controlling travel of vehicle 1. Automatic traveling device 2 is a device for causing vehicle 1 to perform an automatic traveling by controlling the output of engine 3, the disengagement of clutch 4 and the shift of transmission 5, and includes a plurality of control devices.

Specifically, automatic traveling device 2 includes engine ECU (engine control device) 10, power transmission ECU (power transmission control device) 11, target vehicle velocity setting device 13, increase/decrease value setting device 14, road information acquisition device 20, vehicle information acquisition device 30, and travel control device 100.

Engine ECU 10, power transmission ECU 11 and travel control device 100 are connected to each other by an on-vehicle network, so that necessary data and control signals can be transmitted to and received from each other.

Engine ECU 10 controls the output of engine 3. Power transmission ECU 11 controls the disengagement of clutch 4 and the shift of transmission 5.

Target vehicle velocity setting device 13 sets target vehicle velocity V (see FIG. 3) during the automatic traveling of vehicle 1 to travel control device 100.

Increase/decrease value setting device 14 sets velocity decrease value −V1 and velocity increase value +V1 at the automatic traveling of vehicle 1 in travel control device 100. These values V, −V1 and +V1 are parameters used for automatic travel of vehicle 1.

Target vehicle velocity setting device 13 and increase/decrease value setting device 14 include, for example, an information input interface such as a display with a touch panel disposed on a dashboard (not illustrated) of a driver's seat, and receive the setting of the parameters from the driver. Target vehicle velocity V, velocity decrease value −V1, and velocity increase value +V1 are referred to as “setting information” as appropriate.

Road information acquisition device 20 acquires road information indicating the road condition and the current position of vehicle 1, and outputs the road information to travel control device 100. For example, road information acquisition device 20 includes current position acquisition device 21 which is a receiver of a satellite positioning system (GPS), weather acquisition device 22 which acquires weather during traveling, and ambient sensor 23 which detects a distance to a vehicle traveling around vehicle 1 (such as a preceding vehicle and a parallel traveling vehicle) and a vehicle velocity difference.

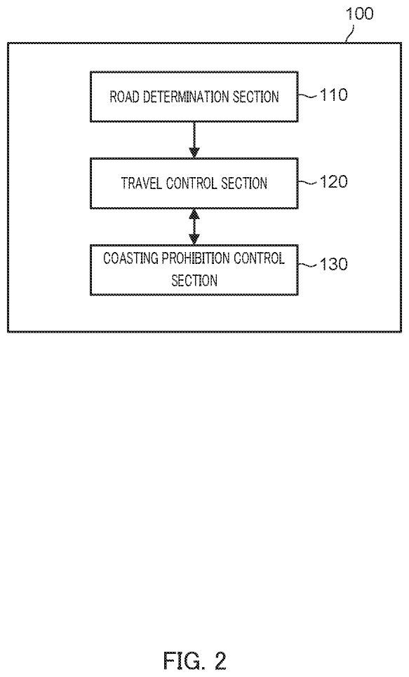

It is preferable that the road information includes road gradient information indicating the gradient of each point of the road, in consideration of the traveling schedule generated by travel control device 100 (travel control section 120 in FIG. 2). The road gradient information is data describing the altitude (road altitude) of the corresponding positions in association with the horizontal positions (latitude/longitude information or the like) of each road.

Vehicle information acquisition device 30 acquires vehicle information indicating the operation contents of the driver and the state of vehicle 1 and outputs the vehicle information to travel control device 100. For example, vehicle information acquisition device 30 includes: accelerator sensor 31 configured to detect a depression amount of an accelerator pedal; brake switch 32 for detecting whether or not a brake pedal is depressed; shift lever 33; turn signal switch 34; and vehicle velocity sensor 35 for detecting the velocity of vehicle 1.

Travel control device 100 generates a traveling schedule including driving travel and N coasting based on the setting information, road information, and vehicle information described above.

Then, travel control device 100 controls each part of vehicle 1 so that vehicle 1 travels in accordance with the generated traveling schedule.

Although not illustrated, engine ECU 10, power transmission ECU 11, and travel control device 100 include, for example, a Central Processing Unit (CPU), a storage medium such as a Read Only Memory (ROM) storing a control program, a working memory such as a Random Access Memory (RAM), and a communication circuit, respectively. In this case, for example, the function of each part described above constituting travel control device 100 is realized by the CPU executing the control program. Note that all or part of engine ECU 10, power transmission ECU 11, and travel control device 100 may be integrally formed.

<Configuration Example of Travel Control Device 100>

Next, the configuration of travel control device 100 will be described with reference to FIG. 2. FIG. 2 is a block diagram showing an example of the configuration of travel control device 100.

As illustrated in FIG. 2, travel control device 100 includes road determination section 110, travel control section 120, and coasting prohibition control section 130.

Next, road determination section 110 will be described.

Based on the road information, road determination section 110 determines whether or not road on which vehicle 1 travels is a predetermined road, and outputs the determination result to travel control section 120. The predetermined road is a road on which vehicle 1 can be N coasting, and is, for example, a road including a downhill such that vehicle 1 is accelerated.

Further, travel control section 120 generates a traveling schedule including the driving travel and the N coasting, and drives vehicle 1 according to the generated traveling schedule based on the current position of vehicle 1.

For example, at the time of driving travel, travel control section 120 controls the fuel injection amount of engine 3 via power transmission ECU 11 to thereby realize traveling at a velocity according to the traveling schedule. Note that the details of the schedule will be described later.

For example, when the vehicle is N coasting, travel control section 120 disconnects clutch 4 via power transmission ECU 11. Further, travel control section 120 controls the respective parts (foot brake 41, retarder 42, and auxiliary brake 43) of braking device 40 to stop vehicle 1. Hereinafter, the braking of vehicle 1 by one or more of the components of braking device 40 may be simply referred to as “braking of vehicle 1”.

Travel control section 120 performs control to switch the traveling state of vehicle 1 to either the driving travel or the N coasting in the generated traveling schedule.

Specifically, when the road on which vehicle 1 travels is a predetermined road and the velocity of vehicle 1 acquired from vehicle velocity sensor 35 is within a predetermined range, vehicle 1 is switched from the driving travel to the N coasting. When the velocity of vehicle 1 falls outside the predetermined range during N coasting, travel control section 120 switches vehicle 1 from the N coasting to the driving travel.

The predetermined range is a range of a velocity set based on target vehicle velocity V at the time of automatic traveling of vehicle 1, and is set according to a predetermined road to be described later.

Travel control section 120 sequentially outputs travel mode information indicating whether or not the vehicle is the N coasting to coasting prohibition control section 130.

Coasting prohibition control section 130 controls travel control section 120 to prohibit the start of the N coasting in vehicle 1 until the predetermined time elapses after vehicle 1 is switched from the N coasting to the driving travel.

For example, when the vehicle velocity exceeds the maximum velocity (V+V1 in FIG. 3) in a predetermined range in the N coasting, the traveling of the vehicle is switched from the N coasting to the driving travel. In the case of driving travel, auxiliary brake 43 is operated so as to adjust the velocity of vehicle 1 to target vehicle velocity V, and the velocity decreases to target vehicle velocity V lower than the maximum velocity in a predetermined range. Since the velocity of auxiliary brake 43 is greatly reduced from the velocity at which the velocity exceeds the maximum velocity (V+V1) to target vehicle velocity V, the driver is likely to feel uncomfortable. Further, since auxiliary brake 43 is continuously operated until the velocity reaches target vehicle velocity V, the fuel efficiency of the vehicle may be lowered.

However, in the present embodiment, when the vehicle is switched from the N coasting to the driving travel by travel control section 120, when the velocity is reduced to predetermined velocity V2 above target vehicle velocity V, the braking of vehicle 1 by auxiliary brake 43 is released. Here, predetermined velocity V2 is a velocity between the allowable maximum velocity (V+V1) and target vehicle velocity V. More specifically, predetermined velocity V2 is a velocity obtained by subtracting a constant velocity (for example, a velocity for canceling the influence of hysteresis) from the allowable maximum velocity (V+V1).

Further, during the operation of auxiliary brake 43, the engine is likely to generate hunting due to interference between the braking of the N coasting and the control of auxiliary brake 43, such as when switching from the driving travel to the N coasting.

However, in the present embodiment, since the start of the N coasting in vehicle 1 is prohibited for a predetermined time after the coasting prohibition control section 130 switches from the N coasting to the driving travel, the occurrence of hunting can be suppressed because the control of the N coasting and the control of auxiliary brake 43 do not interfere with each other. The predetermined time is a time during which the driver of vehicle 1 does not feel troublesome to switch between the N coasting and the driving travel.

On the other hand, the predetermined road including a downhill on which the N coasting is performed includes a downhill such that vehicle 1 is accelerated.

The road is a road including a downhill such that gradient resistance Fs of the slope is smaller than the sum of air resistance Fa for vehicle 1 and rolling resistance Fr for vehicle 1 (for example, see solid line 211 illustrated in FIG. 3). When vehicle 1 is N coasting on the road, vehicle 1 is caused to travel by increasing the velocity as it is in the downhill portion as indicated by solid line 212 as illustrated in FIG. 3.

In the case of the N coasting, since fuel is not injected, fuel efficiency can be improved compared to a driving travel in which fuel is continuously injected.

On the road, the predetermined range is set such that the maximum velocity is V+V1 and the minimum velocity is V−V1, for example, based on the setting information described above. In other words, when a predetermined road includes a downhill such that vehicle 1 is accelerated, travel control section 120 sets a predetermined range within a range from V+V1 (first velocity) which is larger than target vehicle velocity V, to V−V1 (second velocity) which is smaller than target vehicle velocity V.

Road determination section 110 determines whether or not the road is a predetermined road including a downhill such that vehicle 1 is accelerated. The determination of the predetermined road is performed by comparing the sum of air resistance Fa and rolling resistance Fr with gradient resistance Fs.

Specifically, when gradient resistance Fs is larger than the sum of air resistance Fa and rolling resistance Fr, road determination section 110 determines that the road is a predetermined road including a downhill such that vehicle 1 is accelerated.

Gradient resistance Fs, air resistance Fa, and rolling resistance Fr are calculated by the following expressions (1) to (3), where M is the current vehicle weight of vehicle 1, g is the gravity acceleration, μ is the rolling resistance coefficient of vehicle 1, λ is the air resistance coefficient of vehicle 1, θ is the average gradient of the N coasting portion, and V0 is the velocity of vehicle 1.

[Expression 1]

Fs=Mg sin θ (1)

[Expression 2]

Fa=λ·V0²·g (2)

[Expression 3]

Fr=μ·Mg·cos θ (3)

Next, the details of a traveling schedule used by travel control section 120 will be described. FIG. 3 is a diagram illustrating an example of road gradient information and a traveling schedule on a road including downhill such that vehicle 1 is accelerated.

For example, travel control section 120 sequentially generates a traveling schedule corresponding to a predetermined length of time from the current time or a predetermined travel distance from the current position of vehicle 1 at regular intervals. First, an example of a traveling schedule on the predetermined road including a downhill such that vehicle 1 is accelerated will be described.

Such a traveling schedule is generated, for example, so that the moving average velocity is the target vehicle velocity V, the allowable maximum velocity in the N coasting is Vmax=V+V1 or less, and the traveling condition that the allowable minimum velocity in the N coasting is equal to or larger than Vmin=V−V1 is satisfied.

Travel control section 120 generates a traveling schedule for actively performing the N coasting on the basis of the road gradient information.

The road gradient information includes, for example, information indicating the road altitude for each horizontal distance (route) from current position L0 of vehicle 1, as indicated by solid line 211 in FIG. 3. It is also possible to replace the horizontal distance from current position L0 of vehicle 1 with the elapsed time from the current time. Further, the road altitude may be replaced with a road gradient based on the relationship between the road altitude and the front and rear road altitudes. The road gradient information of solid line 211 indicates that current position L0 of vehicle 1 is on the downhill side.

For example, as indicated by solid line 212 in the lower side of FIG. 3, travel control section 120 determines to maintain the N coasting to position L1 where the velocity exceeds allowable maximum velocity Vmax, that is, (V+V1).

Specifically, travel control section 120 calculates position L at the velocity (V+V1) in the case where the N coasting is performed by plugging in (V+V1) for Vt in the following expression (4) to obtain distance Δx.

$$\begin{matrix}[ Expression 4 ] & \\ Vt = \sqrt{\frac{2}{M} \{ \frac{1}{2} MV {0}^{2} + Mgh 0 - ( Mght + λ \cdot V {0}^{2} \cdot g \cdot \frac{Δ x}{cos θ} + μ \cdot Mg \cdot Δ x ) \}} & ( 4 )\end{matrix}$$

Here, M is the current vehicle weight of vehicle 1, g is gravity acceleration, h0 is the altitude of current position L0 of vehicle 1, ht is the altitude of position Lt, μ is the rolling resistance coefficient of vehicle 1, Δx is the distance in the horizontal direction from current position L0 to position Lt (route), 0 is the average gradient of a portion where vehicle 1 performs the N coasting, and V0 is a current velocity of vehicle 1.

Further, travel control section 120 switches the vehicle to the driving travel at position L1 and brakes the vehicle by auxiliary brake 43, and when the velocity decreases to predetermined velocity V2 above target vehicle velocity V (position L2 illustrated in FIG. 3), the braking of vehicle 1 by auxiliary brake 43 is released (refer to the lower side in FIG. 3). Further, travel control section 120 determines a travel schedule having a content for maintaining the driving travel until a predetermined time elapses after switching to the driving travel.

When the predetermined time has elapsed, travel control section 120 switches to the N coasting, and generates a travel schedule having a content for maintaining the N coasting to a position (not shown) where the velocity is lower than allowable minimum velocity Vmin, that is, less than (V−V1). Also in this case, travel control section 120 calculates the position at velocity (V−V1) in the case where the N coasting is performed by using the expression (4).

When calculated estimated vehicle velocity Vt is equal to or higher than the set allowable minimum velocity Vmin, travel control section 120 maintains the vehicle as is when the vehicle is during N coasting and determines to switch the vehicle to the N coasting state when the vehicle is during driving travel. That is, travel control section 120 creates a traveling schedule as indicated by solid line 212 in FIG. 3, for example, and controls vehicle 1 according to the traveling schedule.

The traveling schedule including the interval of the N coasting determined based on the road gradient information effectively improves the fuel efficiency of vehicle 1. Further, by traveling vehicle 1 according to the traveling schedule, it is not necessary for the driver to perform a sequential accelerator operation.

Further, since the start of N coasting is prohibited for the predetermined time after the switching to the driving travel, the hunting of the gear caused by the switching between the driving travel and the N coasting can be suppressed.

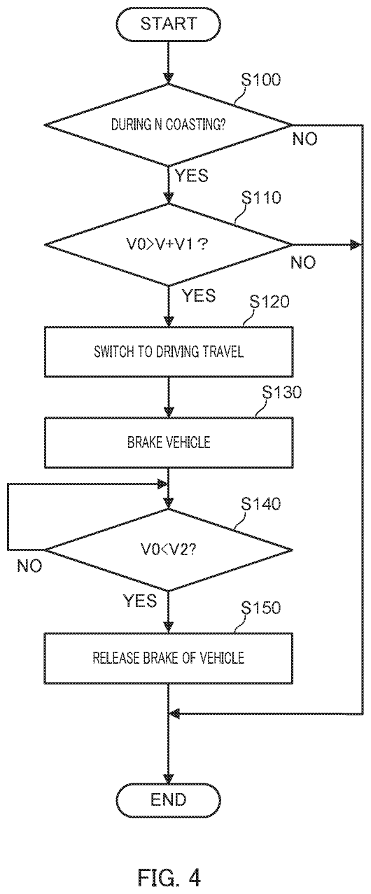

Next, a description will be given of an example of the operation of travel control section 120. FIG. 4 is a flowchart showing an example of an operation of the travel control performed by travel control section 120. The processing in FIG. 4 is carried out, for example, during traveling of vehicle 1.

As illustrated in FIG. 4, travel control section 120 determines whether or not the vehicle is N coasting (step S100). As a result of the determination, if it is determined that the vehicle is not N coasting (step S100: NO), the process ends. On the other hand, during N coasting is performed (step S100: YES), the process proceeds to step S110.

In step S110, travel control section 120 determines whether or not current velocity V0 of the vehicle exceeds allowable maximum velocity (V+V1) of the predetermined range.

When velocity V0 does not exceed allowable maximum velocity (V+V1) (step S110: NO), the process ends. On the other hand, when velocity V0 exceeds allowable maximum velocity (V+V1) (step S110, YES), the process proceeds to step S120.

In step S120, travel control section 120 switches the travel of the vehicle from the N coasting to the driving travel.

Next, travel control section 120 brakes the vehicle by auxiliary brake 43 (step S130).

Next, travel control section 120 determines whether or not current vehicle velocity V0 is less than predetermined velocity V2 (step S140).

When velocity V0 is equal to or greater than predetermined velocity V2 as a result of the determination (NO in step S140), the process returns to step S140. On the other hand, when velocity V0 is less than predetermined velocity V2 (YES at step S140), travel control section 120 releases the braking of vehicle 1 by auxiliary brake 43 (step S150).

According to the present embodiment configured as described above, when the velocity of the vehicle exceeds allowable maximum velocity (V+V1) in the predetermined range, travel control section 120 switches the travel of the vehicle from the N coasting to the driving travel and brakes vehicle 1 by auxiliary brake 43, and when velocity V0 decreases to predetermined velocity V2 above target vehicle velocity V, the braking of vehicle 1 by auxiliary brake 43 is released. Accordingly, since the velocity of the vehicle is not greatly reduced from allowable maximum velocity (V+V1), the driver's discomfort can be reduced. Further, since the velocity of the vehicle is not lowered to target vehicle velocity V, the fuel efficiency of the vehicle can be improved.

The start of the N coasting is prohibited until a predetermined time elapses after the driving of the vehicle is switched from the N coasting to the driving travel. Thus, the control of the N coasting and the control of auxiliary brake 43 do not interfere with each other, so that the hunting of the engine can be prevented.

In the above embodiment, when the vehicle velocity exceeds the allowable maximum velocity, auxiliary brake 43 is operated to brake the vehicle, but this disclosure is not limited thereto. For example, other braking devices 40 such as foot brake 41 and retarder 42 may be operated, and two or more of the respective parts of braking device 40 may be braked.

It should be noted that the above embodiment is merely an example of the implementation of this disclosure, and is not intended to limit the scope of this disclosure. That is, this disclosure may be embodied in various forms without departing from the spirit or essential characteristics thereof.

This application is based on Japanese Patent Application No. 2017-056564, filed on Mar. 22, 2017, the contents of which are incorporated herein by reference.

### INDUSTRIAL APPLICABILITY

The travel control device of this disclosure is useful as a travel control device, a vehicle, and a travel control method which are required to reduce a driver's discomfort and to further improve the fuel efficiency of the vehicle.

### REFERENCE SIGNS LIST

1 vehicle
2 automatic traveling device
3 engine
4 clutch
5 transmission
6 propulsion shaft
7 differential device
8 drive shaft
9 wheel
10 engine ECU
11 power transmission ECU
13 target vehicle velocity setting device
14 increase/decrease value setting device
20 road information acquisition device
21 current position acquisition device
22 weather acquisition device
23 ambient sensor
30 vehicle information acquisition device
31 accelerator sensor
32 brake switch
33 shift lever
34 turn signal switch
35 vehicle velocity sensor
40 braking device
41 foot brake
42 retarder
43 auxiliary brake
100 travel control device
110 road determination section
120 travel control section
130 coasting prohibition control section

What is claimed is:

1. A travel control device that performs a switching control for traveling of a vehicle between driving travel for causing the vehicle to travel while maintaining the velocity at a target vehicle velocity and inertia traveling for allowing the vehicle to travel by inertia, the travel control device comprising:
a travel control section that switches the travel of the vehicle from inertia traveling to driving travel and brakes the vehicle when the velocity of the vehicle exceeds an allowable maximum velocity of a predetermined range during inertia traveling, and that releases the brake of the vehicle when the velocity of the vehicle decreases to a predetermined velocity above the target vehicle velocity.

2. The travel control device according to claim 1, wherein the predetermined velocity is a velocity between the allowable maximum velocity and the target vehicle velocity.

3. The travel control device according to claim 1, further comprising a coasting prohibition control section that controls the travel control section to prohibit start of the inertia travel of the vehicle until a predetermined time elapses after the travel of the vehicle is switched from the inertia traveling to the driving travel.

4. A vehicle, comprising the travel control device according to claim 1.

5. A travel control method for performing a switching control for traveling of a vehicle between driving travel for causing the vehicle to travel while maintaining the velocity at a target vehicle velocity and inertia traveling for allowing the vehicle to travel by inertia, the travel control method comprising:
switching the travel of the vehicle from inertia traveling to driving travel and braking the vehicle when the velocity of the vehicle exceeds an allowable maximum velocity of a predetermined range during inertia traveling, and releasing the braking of the vehicle when the velocity of the vehicle decreases to a predetermined velocity above the target vehicle velocity.
